(19) United States
(12) Patent Application Publication
(10) Pub. No.: US 2002/0133397 A1
(43) Pub. Date: Sep. 19, 2002

(54) Distributed ad flight management

(76) Inventor: Christopher M. Wilkins, Seattle, WA (US)

Correspondence Address: COLUMBIA IP LAW GROUP, PC, 10260 SW GREENBURG ROAD, SUITE 820, PORTLAND, OR, 97223, US

(21) Appl. No.: 09/761,536

(22) Filed: Jan. 16, 2001

(51) Int. Cl. G06F 17/60

(52) U.S. Cl. 705/14; 702/181; 705/10

(57) ABSTRACT

An advertisement server makes an initial selection and provision of a number of advertisements for a number of client devices for presentation in accordance with corresponding desired flight profiles to be achieved for the advertisements. The provisions include one or more presentation parameters to govern the rates in which the provided advertisements are to be presented. The client devices selectively present the advertisements in accordance with the governing presentation parameters. Further, the client devices report their presentations. The advertisement server in turn repeats the selection and provision of advertisements further taking into consideration the reports.

### BACKGROUND OF THE INVENTION

1. Field of the Invention

The present invention relates to the field of data processing. More specifically, the present invention relates to the art of managing presentation of advertisements to online users.

2. Background Information

With the advent of public data networks, such as the Internet, and content servers, such as the World Wide Web (WWW), technologies associated with presenting advertisements to online users have become of great interest to many artesian. The general core technology for presenting advertisements to online users is known in the art. See for examples, U.S. Pat. Nos. 5,740,540, 5,838,790, 5,948,061 and 6,119,098. However, none had adequately addressed the issue of “flight management”.

In presenting advertisements, it is well known that in order to maximize the effectiveness of an advertising campaign, advertisers would often desire to have the presentations “spread out” over an extended campaign period, as opposed to having the presentations be made in a “burst”, over a narrow time period. Further, as opposed to a straight linear rate over the campaign period, advertisers often desire the presentations be made in accordance with certain non-linear profiles, also known as flight profiles (FIGS. 3a & 3b).

However, because content servers such as web servers of the WWW often have to service millions of users, it is important for the content servers to be very efficient and responsive in serving user requests. Thus, it is undesirable to burden the content servers to make a lot of real time complex decisions to manage advertisement presentation. Moreover, it is generally desirable for content servers to be architected in a scalable manner, i.e. not requiring client devices to be tightly coupled to the content servers before client devices may enjoy the services or benefits offered the content servers.

Accordingly, an approach to managing advertisement presentations (in accordance with desired flight profiles) that is efficient and scalable is desired.

### SUMMARY OF THE INVENTION

In accordance with the present invention, an advertisement server makes an initial selection and provision of a number of advertisements for a number of client devices for presentation in accordance with corresponding desired flight profiles to be achieved for the advertisements. The provisions include one or more presentation parameters to govern the rates in which the provided advertisements are to be presented. The client devices selectively present the advertisements in accordance with the governing presentation parameters. Further, the client devices report their presentations. The advertisement server in turn repeats the selection and provision of advertisements further taking into consideration the reports.

In one embodiment, the advertisement server makes the advertisement selections probabilistically. In one embodiment, the selection is made via at least two stages, with the first stage establishing a candidate pool of advertisements. Further, the advertisement server employs in the second stage, a set of weights commensurate with the residual presentations of the advertisements to be made to achieve the corresponding desired flight profiles when making the probabilistic selections. The advertisement server periodically re-determines the weights based on aggregated presentations made (as reported by the client devices). In one embodiment, a minimum and a maximum presentation parameter are employed as the governing presentation parameters for each advertisement, which are determined in accordance with the desired flight profile of the advertisement, and the point in time in the flight.

In one embodiment, the advertisements are selected and provided to the client devices in response to their requests, which are explicitly made periodically to ensure an ample supply of eligible advertisements are available in the corresponding local caches. In one embodiment, the requests are also deemed to have been made per online content searches performed by the client devices.

In one embodiment, the advertisement server includes a number of transaction engines to select and provide the advertisements, and accept presentation reports from the client devices, a logging service to aggregate the presentations reported, and a manager to periodically re-determine the selection parameters employed in the selection process.

In one embodiment, the advertisement server is implemented using a “collection” of one or more data processing servers.

### BRIEF DESCRIPTION OF DRAWINGS

The present invention will be described by way of exemplary embodiments, but not limitations, illustrated in the accompanying drawings in which like references denote similar elements, and in which:

FIGS. 1 and 2a-2b illustrate a network view and two method views of the distributed advertising management system of the present invention, in accordance with one embodiment;

FIGS. 3a-3b illustrate a total impression view and delivery rate view of a number of example advertisement flight profiles;

FIG. 4 illustrates the advertisement database of FIG. 1, in accordance with one embodiment;

FIG. 5 illustrates the operational flow of the relevant aspects of the advertisement manager of FIG. 1, in accordance with one embodiment;

FIGS. 6-7 illustrate the operational flow of the relevant aspects of the transaction engines of FIG. 1, in accordance with one embodiment;

FIG. 8 illustrates the operational flow of the relevant aspects of the logging services of FIG. 1, in accordance with one embodiment;

FIG. 9 illustrates the local advertisement cache of FIG. 1, in accordance with one embodiment;

FIG. 10 illustrates a queue structure employed by the advertisement management extension of FIG. 1, in accordance with one embodiment;

FIG. 11 illustrates the operational flow of the relevant aspects of the advertisement management extension of FIG. 1, in accordance with one embodiment; and

FIG. 12 illustrates a computer system suitable for use as either a client or a server to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented in terms of operations performed by a processor based device, using terms such as data, tables, selecting, transmitting, displaying, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor include microprocessors, micro-controllers, digital signal processors, and the like, that are standalone, adjunct or embedded.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

### Overview

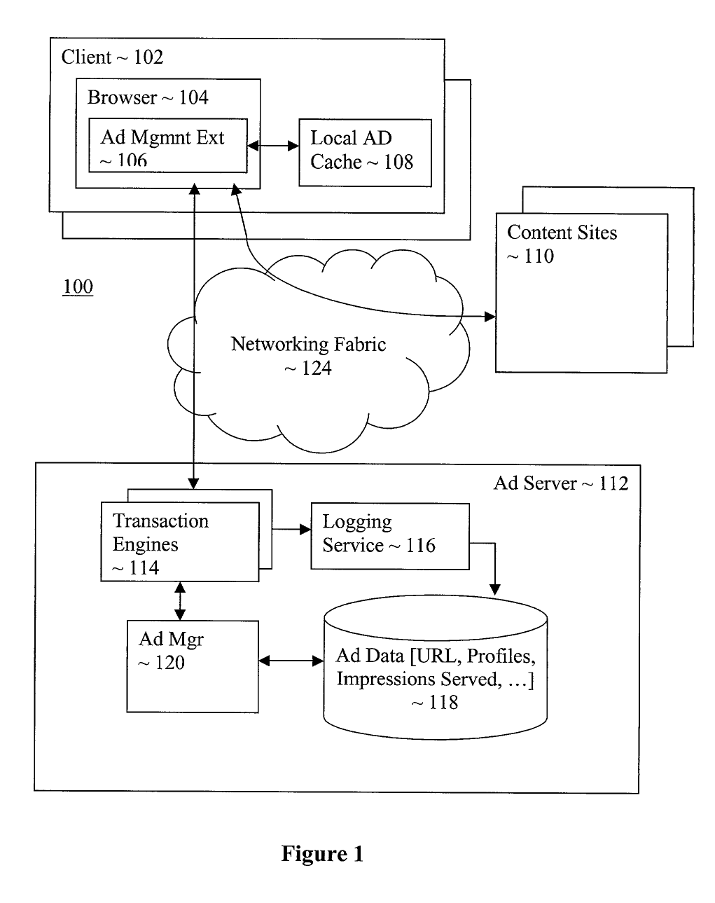

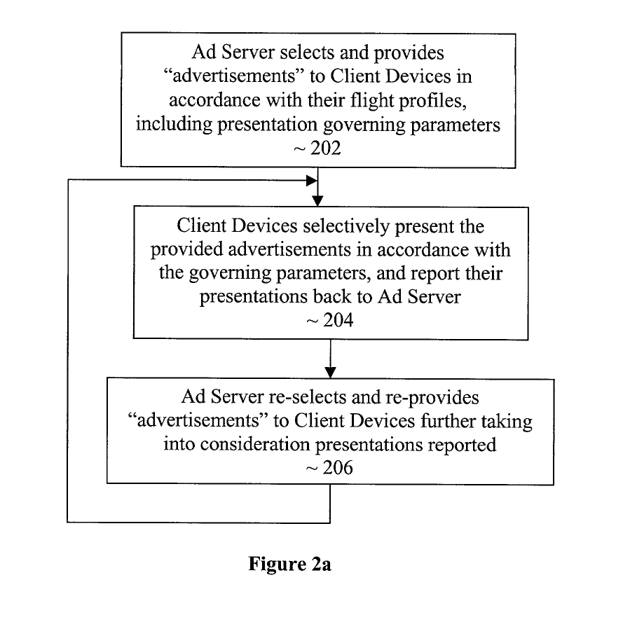

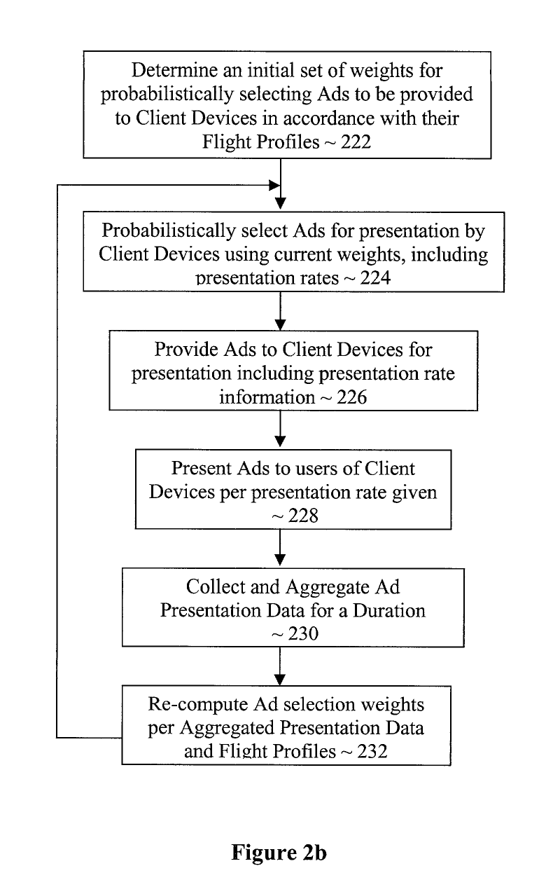

Referring now first to FIGS. 1 and 2a-2b, wherein three diagrams illustrating a network view and two method views of the distributed advertising management system the present invention, in accordance with one embodiment, are shown. As illustrated in FIG. 1, an advertisement server 112 is equipped with the teachings of the present invention to manage advertisement presentation to online users of client devices 102, in accordance with corresponding desired flight profiles of the advertisements. Client devices 102 may be executing various online applications, including e.g. accessing content servers 112. In one embodiment, the types of advertisements provided are customized in accordance with the demographics of the users of client devices 102 and/or the subject matters of the online contents. Subject matters may be indicated by keywords and/or topic categories. Client devices 102, ad server 112 and content sites 110 are all coupled to each other through networking fabric 124.

As illustrated in FIG. 2a, at start of operation, ad server 112 would make an initial selection and provision of a number of advertisements for a number of client devices 102 for presentation in accordance with corresponding desired flight profiles to be achieved for the advertisements (block 202). The provisions would include one or more presentation parameters to govern the rates in which the provided advertisements are to be presented by client devices 102. Client devices 102 in turn would selectively present the advertisements in accordance with the governing presentation parameters (block 204). Further, client devices 102 would report their presentations back to ad server 112. Ad server 112 in turn would repeat the selections and provisions of advertisements, further taking into consideration the presentations reported (block 206). The process continues iteratively, and in due course, presentation of the advertisements in accordance with the corresponding desired flight profiles is achieved.

Referring back to FIG. 1, for the illustrated embodiment, ad server 112 is constituted with a number of transaction engines 114, logging service 116, manager 120, and database 118. Database 118 is employed to store various associated information of the advertisements to be presented, including operational data. Of particular interest are data that describe the locations where the advertisements may be retrieved, the desired flight profiles of the advertisements to be presented, and the actual presentations or impressions served.

As will be described in more detail below, transaction engines 114 are employed to interact with client devices 102, probabilistically selecting and providing client devices 102 with advertisements for presentation, in accordance with at least the desired flight profiles of the advertisements, employing a number of selection parameters. In one embodiment, as alluded to earlier, the types of advertisements selected are customized in view of the demographics of the users of client devices 102, and/or subject matters of the online searches being conducted by the users of client devices 102. Included with the advertisements provided to client devices 102 are presentation parameters governing at least the rates the advertisements may be presented by client devices 102. Transaction engines 114 further accept reports of presentations of the provided advertisements from client devices 102, and periodically transfer the reported presentation data to logging service 116 for aggregation.

Logging service 116 periodically accepts transfers of the presentation reports from transaction engines 114. In response, logging service 116 aggregates the reported presentations. Manager 120 in turn periodically uses the aggregated presentations and the corresponding flight profiles, and re-determines the selection parameters to be employed by transaction engines 114 for making the earlier described selections and provisions of advertisements to client devices 120 for presentation.

Over on the client side, client devices 102 are equipped with enhanced generic user agents, such as browsers 104, each enhanced with an advertising management extension 106. Advertising management extension 106 is designed to cooperate with ad server 112 to facilitate advertisement presentations in accordance with the present invention. More specifically, among the various functions performed by advertisement management extension 106 is the function for requesting ad server 112 to pre-provide its host client device 102 with a number of advertisements. In one embodiment, advertisement management extension 106 is implemented as additional COM objects of the browser (“container”). For the illustrated embodiment, for efficiency of operation, each of client devices 102 also includes a local cache 108 for storing at least the control information of the “provided” advertisements. For the illustrated embodiment, local cache 108 is also used to cache the “provided” advertisements. [In another embodiment, the advertisements themselves are not actually provided. Only control information (which includes the location of the actual advertisements) are provided and cached. The advertisements themselves are retrieved from the identified locations at playtime and cached automatically by the browser into the standard html page cache.]

Further, some of browsers 104 may also each additionally enhanced with a meta search extension for conducting meta searches directly from client devices 102 (without having operational dependency on prior art meta search servers, such as Alta Vistas and the like). For some of these embodiments, either advertisement management extension 106 or the meta search extension may inform ad server 112 of the subject matters of the online searches being conducted by the users of client devices 102, thereby enabling these subject matters to influence the advertisements being selected for presentation. In some embodiments, the manner in which the subject matters are taken into account is by treating a notice of a search request as a request for additional provision of advertisements. Client based meta search is the subject matter of co-pending application, entitled “Client Based Meta Search”, filed on Dec. 6, 2000, application Ser. No. 09/731,890, which is hereby fully incorporated by reference.

The interactions between enhanced browsers 104 of client devices 102 and transaction engines 114 of ad server 112 are advantageously architected in a scalable manner such that any one of transaction engines 114 may service anyone of client devices 102 (at the direction of a load balancer (not shown)). In fact, a client device 102 may be serviced by different transaction engines 114 for different transactions during the same online session. Transaction engines 114, logging services 116 and manager 120 are all “loosely” coupled to each other.

FIG. 2b illustrates the method of the present invention in further details, in accordance with one embodiment. As illustrated, the method of the present invention begins at block 222 with manager 120 determining an initial set of weights for transaction engines 114 to probabilistically select and provide advertisements for client devices 102, in accordance with the flight profiles of the advertisements.

Then, transaction engines 114 probabilistically select the advertisements for presentation using the current weights, block 224. Transaction engines 114 also determine and include a number of presentation parameters governing the rates of presentations of the provided advertisements by client devices 102, block 226. In one embodiment, the governing parameters include a minimum and a maximum number of presentations for each advertisement, denoting the minimum and maximum number of presentations to be made for an advertisement by a receiving client device.

Thereafter, client devices 102 select and present the advertisements to their users, in accordance with the included governing presentation parameters, block 228. The local selections and presentations are made without requiring further interactions or interventions by ad server 112. Client devices 102, in real time or in batch, report the presentations to ad server 112, block 230.

Logging service 116 periodically aggregates the reported presentations. Also periodically, manager 120 re-determines the weights to be employed by transaction engines 114 in the selections and provisions of advertisements to client devices 102, further taking into consideration the reported presentations, block 232.

Thus, the present invention advantageously enables advertisements to be presented to users of client devices 102 in accordance with the corresponding flight profiles desired by the advertisers, but without requiring complex advertisement management decisions to be made in real time (by transaction engines 112) to effectuate the desired flight control, and ad server 112 is highly scalable, allowing more or less transaction engines 114 to be deployed.

Referring back to FIG. 1, in one embodiment, one or more data processing servers are employed to implement ad server 112. Except for the advertisement teachings of the present invention, client devices 102, the implementing data processing servers of ad server 112, the constituting elements of network fabrics 124 as well as content sites 110 are all intended to represent a broad range of these elements known in the art. The implementing data processing servers may be any one of a number of such servers available from e.g. Sun Microsystems of Menlo Park, Calif., or IBM of Armonk, N.Y. The client devices may be computing devices of any one of a number of form factors, including but are not limited, palm sized, notebook sized, or desktop computers, such as those available from Hewlett Packard of Palo Alto, Calif., as well as set top devices. Browsers 104, except for advertising manager extension 106, may be any one of a number of browsers known in the art, including but are not limited to Internet Explorer, available from Microsoft, Inc., of Redmond, Wash. Similarly, the constituting elements of networking fabrics may be any one of a number of networking routing, switching or elements of the like known in the art, including but are not limited to such devices available from Cisco Systems of San Jose, Calif., or Juniper Systems of Sunnyvale, Calif. Thus, except for transaction engines 114, logging service 116, manager 120, and advertisement management extension 106, the remaining elements illustrated in FIG. 1, will not be further described.

### Database

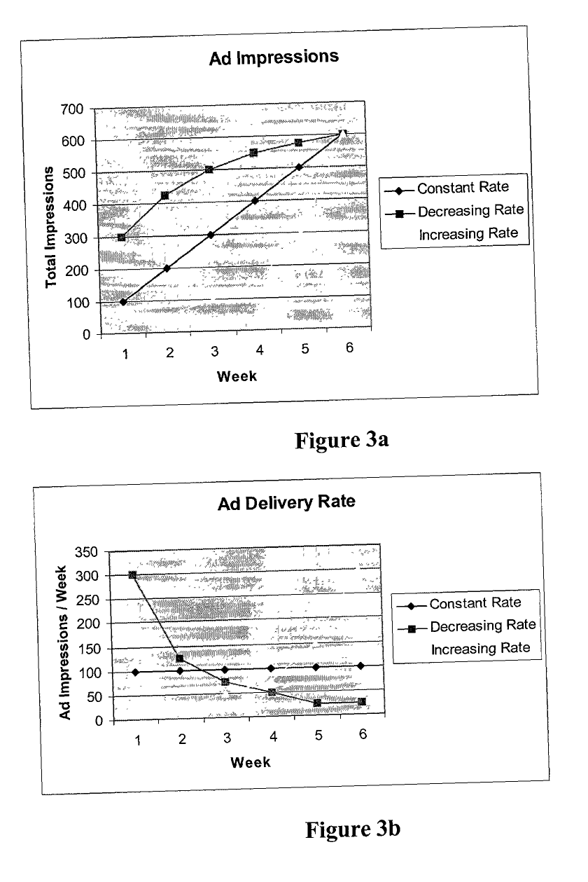

As described earlier, database 118 of ad server 112 is used to store the associated information of the advertisements to be presented, including in particular the locations where the advertisements may be retrieved. The manner in which advertisements are distributively stored is unimportant to the practice of the present invention. The advertisements may be stored using any one of a number of data organizations known in the art. [In alternate embodiments, some or all of the advertisements to be presented may be centrally stored on ad server 112 instead.] FIG. 4 illustrates a data structure suitable for use to store the more essential advertisement associated information for practice the present invention. As illustrated, for the embodiment, database 118 includes table/view 400 having a number of columns, in particular, column 402 for storing identifiers of the advertisements, column 403 for storing the URLs of the advertisements, columns 406 for storing data describing the flight profiles, such as the starting and ending dates of the campaign or profile, the desired number of impressions, and the desired rate/profile the impressions are to be presented, and columns 408 for storing data reflecting the aggregated reported presentations of the advertisements. Of course, this embodiment can also be considered as a view onto a more complex relation between multiple tables.

Moreover, for the embodiment, table/view 400 further includes column 404 for storing a number of selection criteria. As described earlier, in some embodiments, the selection of advertisements are further customized in accordance with the demographics of the users of client devices 102, and/or subject matters of online searches being conducted by the users of client devices 102. For these embodiments, the selection criteria may include demographic information of the target groups of the advertisements, such as age, sex, and so forth, as well as subject matter information such as, books, records, videos, and so forth.

Database 118 may be implemented using anyone of a number of database management systems known in the art, including but are not limited to Oracle, available from Oracle Corp., of Redwood Shore, Calif., or DB2, available from IBM Corp., of Armonk, N.Y.

### Determining Selection Weights

Recall from earlier description that in one embodiment, transaction engines 114 probabilistically select and provide advertisements for client devices 102. More specifically, manager 120 determines the selection weights to be employed by transaction engines 114 in performing the probabilistic selections.

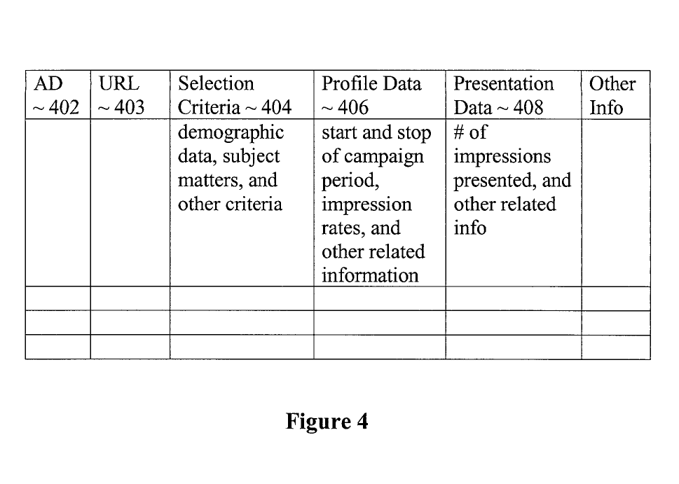

FIG. 5 illustrates a process for determining the selection weights of the advertisements, in accordance with one embodiment. As described earlier, manager 120, determines the selection weights of the advertisements periodically. Initially, manager 120 determines the selection weights of the advertisements in view of the desired flight profiles. In subsequent determinations, manager 120 further makes the determination in view of the reported presentations.

As illustrated in FIG. 5, for the embodiment, during each determination, manager 120 determines the selection weights for the advertisements, one advertisement at a time. At block 502, manager 120 selects an advertisement for analysis. Next, at block 504, manager 120 retrieves the desired flight profile and the actual impressions presented thus far for the selected advertisement. (Naturally, the actual impressions presented thus far for the initial determination is zero.) Upon retrieving the desired flight profile and the actual impressions presented thus far, manager 120 determines the selection weight for the advertisement using the retrieved information, block 506.

In one embodiment, manager 120 determines the selection weight as follows:

1) If it is an initial assignment, manager 120 assigns an initial weight based on the average rate of impressions to be presented for the advertisement. In one embodiment, the initial weight is a weight between 1-255, depending on how the average rate of impressions to be presented for the advertisement compares to the global average rate of impressions to be presented for all advertisements.

2) If it is a subsequent (post initial) determination, manager 120 determines an adjustment to the weight to bring the actual impressions in line with the desired impressions at a given moment in time, and adjusts the weight accordingly. The adjustment is determined using the formula

$$∇ W = {C}_{1} \frac{( {I}_{d} - {I}_{a} )}{{I}_{d}} + {C}_{2} \frac{( {S}_{d} - {S}_{a} )}{{S}_{d}} ,$$

where

a. ∇W is the change in weight being calculated,

b. C₁ and C₂ are empirically determined constants (which vary from embodiment to embodiment depending on the number of clients, their behaviors, and the number of advertisements services, as the initial weights),

c. I_{d} is the desired number of impressions (determined based on the flight profile associated with the advertisement),

d. Iₐ is the actual number of impressions presented thus far for the advertisement,

e. Sₐ is the rate at which the advertisement has been served since the last weight calculation period (Sₐ can be calculated using the equation

$${S}_{a} = \frac{( {I}_{a1} - {I}_{a0} )}{{t}_{1} - {t}_{0}}$$

where Iₐ₁ is the total impressions for this advertisement now, Iₐ₀ is the total impressions for this advertisement at the previous calculation period, t₁ is the time now, and t₀ is the time of the previous calculation period),

f. S_{d} is the desired delivery rate of advertisement for the immediate future (which may be one or more re-calculation periods) according to the flight profile,

The equation employed is made up of two components:

$$\frac{( {I}_{d} - {I}_{a} )}{{I}_{d}}$$

and

$$\frac{( {S}_{d} - {S}_{a} )}{{S}_{d}} .$$

The first component gives the ratio of the difference between desired and actual impressions-to-date, and the desired impressions-to-date. Thus, the value of this component will be 0 when the desired and actual values are the same, negative when the actual value is too high, and positive when the actual value is too low. The second component gives the ratio of the difference between the desired rate of delivery in the immediate future and the actual rate of delivery in the immediate past, and the desired rate of delivery in the immediate future. This adds a damping effect to the adjustment algorithm. For example, if the impressions-to-date values (both actual and desired) are the same, meaning

$$\frac{( {I}_{d} - {I}_{a} )}{{I}_{d}} = 0 ,$$

but actual impressions are being delivered faster than desired, the weight is decreased in an effort to bring the delivery rates in sync, and thus keep the actual impressions-to-date from being greater than the desired value at the next adjustment.

In alternate embodiments, other initial weight ranges or other initial weight assignment approaches may also be employed. Preferably, the initial weight assignment approach should reflect the number of clients, their access behaviors, and the typical number of advertisements being serviced for a particular implementation. The exact numerical values of the initial weights are not very important, because of the feedback adjustment mechanism employed. Similarly, in alternate embodiments, other equations may be employed to quantitatively influence the weight adjustments (which in turn influences the probability of an advertisement getting selected), based on the actual impression presentation experience.

Upon determining the selection weight for the selected advertisement, manager 120 further determines if there are additional advertisements remain to be processed, block 506. If there are additional advertisements that remain to be processed, the process continues back at block 502. Otherwise, manager 120 normalizes the newly determined weights, and terminates the process. In one embodiment, the newly determined weights are normalized back to the weight range, e.g. 0-255 for the earlier mentioned 1-255 initial weight range.

### Probabilistic Advertisement Selection and Determining Governing Presentation Parameters

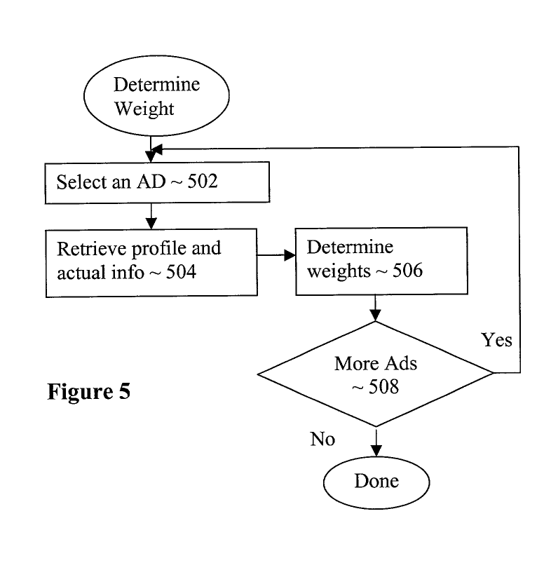

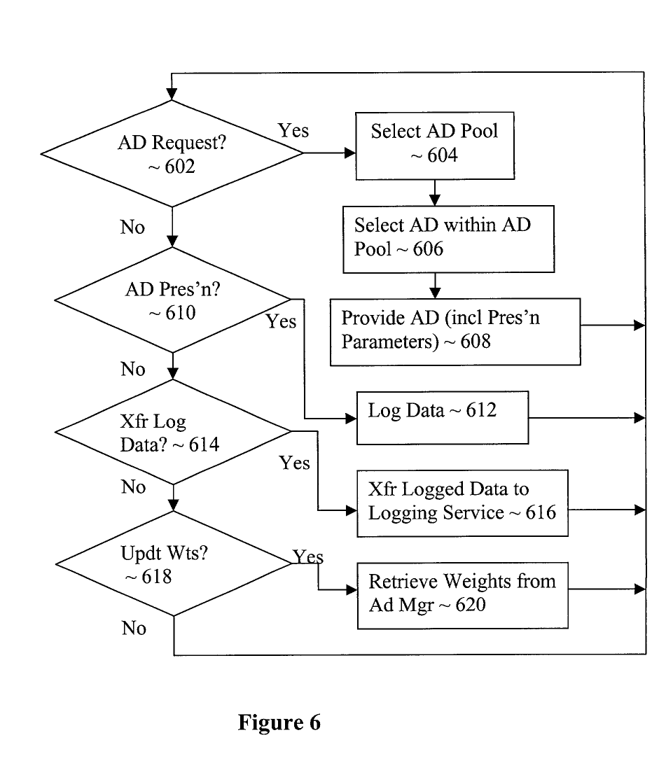

Recall again from earlier description that in one embodiment, transaction engines 114 probabilistically select advertisements for client devices 102. FIGS. 6-7 illustrate a process for making the probabilistic selection, in accordance with one embodiment. The embodiment is a multi-stage embodiment involving at least a first stage where the transaction engine first determines a pool of advertisement candidates, and then probabilistically selects the ultimate advertisements from the candidate pool.

As illustrated in FIG. 6, at block 602, a transaction engine determines if it has been assigned to process an advertisement “request” from a client device. [Recall from earlier description that the “request” may be explicit or implicit from events such as a search request.] If the determination is affirmative, the transaction engine, first determines an eligible advertisement pool, block 604. As alluded to earlier, the advertisement pool is constituted with advertisements that are targeted for recipients having demographic characteristics similar to those of the user of the requesting client device, and/or advertisements targeted for users conducting online searches on subject matters similar to the current search subject matter of the “requesting” client device. In one embodiment, the demographic data of the use of client device and/or the subject matter of the search are advantageously conveyed to transaction engine in real time as part of the request. The advantageous transmission eliminates the needs for a transaction engine to make time consuming database accesses to retrieve the user's demographic profile. Similar practice is also followed with respect to informing a transaction engine of the current subject matter, when informing the transaction engine of an online search request made by a client device.

Upon establishing the eligible advertisement pool (e.g. of M advertisements), the transaction engine would probabilistically select a subset of n advertisements out of the M eligible advertisements (to be described more fully below), block 606. N is pre-determined. Preferably it is reconfigurable for different advertisement publishers, i.e. operators of Ad server 112. Upon making the selection, the transaction engine would determine the governing presentation parameters for the selected advertisements, and then provide the selected advertisements to the requesting client device along with the governing presentation parameters, block 608. Thereafter, the process continues back at block 602.

Skipping to FIG. 7, wherein a more detailed process for probabilistically selecting n advertisements from a pool of M eligible advertisements is illustrated, in accordance with one embodiment. As illustrated, first, a transaction engine determines if n is greater than or equal to M, block 702. If n is greater than or equal M, the entire pool is selected, block 704. If n is less than M, the transaction engine next creates a working array holding the current selection weights of the eligible advertisements, block 706. The transaction engine then sums the selection weights yield sum S, block 708. Then, the transaction engine generates a random number r, that is between the values of 1 through S, block 710, and uses r to select the advertisement, blocks 712-714. The transaction engine selects the advertisement by traversing the working array, and decrementing r with the weight of each advertisement it traversed. For the illustrated embodiment, the advertisement where r is decremented to zero or less than zero, is selected. Further, the weight of the selected item in the working array is set to zero. [As a result, the advertisement will not be selected in the next pass. Further, S will be automatically decremented for the next pass.]

So, upon selecting one advertisement, the transaction engine determines if additional advertisements are to be selected (i.e. whether the number of selected advertisements is still less than n), block 716. If so, the process continues back at block 708, otherwise the selection process is completed.

As described earlier, in one embodiment, each of the selected advertisements are advantageously provided to the requesting client devices with governing presentation parameters. In one embodiment, the governing presentation parameters include a minimum and a maximum parameter. The minimum parameter specifies the minimum number of times the selected advertisement is to be presented, whereas the maximum parameter specifies the maximum number of times the selected advertisement is to be presented. The minimum and maximum parameters are determined in accordance with the desired minimum and maximum impressions per user of the desired flight profile, and the duration of the flight profile. For example, if an advertisement campaign desires a minimum of 5 and a maximum of 20 impressions per user, for a campaign of 6 weeks and a total of 600 impressions, the minimum and maximum presentation parameters may be set and increased over the campaign period as follows (for a constant delivery rate, a decreasing delivery rate or an increasing delivery rate):

Constant Rate

| | change in | | | client | client |
|---|---|---|---|---|---|
| week | impressions | total impressions | rate | min | max |
| 1 | 100 | 100 | 100 | 1 | 4 |
| 2 | 100 | 200 | 100 | 2 | 7 |
| 3 | 100 | 300 | 100 | 3 | 10 |
| 4 | 100 | 400 | 100 | 4 | 14 |
| 5 | 100 | 500 | 100 | 5 | 17 |
| 6 | 100 | 600 | 100 | 5 | 20 |

Decreasing Rate

| | | | | client | client |
|---|---|---|---|---|---|
| week | impressions | total impressions | rate | min | max |
| 1 | 300 | 300 | 300 | 3 | 10 |
| 2 | 125 | 425 | 125 | 4 | 15 |
| 3 | 75 | 500 | 75 | 5 | 17 |
| 4 | 50 | 550 | 50 | 5 | 19 |
| 5 | 25 | 575 | 25 | 5 | 20 |
| 6 | 25 | 600 | 25 | 5 | 20 |

Increasing Rate

| | | | | client | client |
|---|---|---|---|---|---|
| week | impressions | total impressions | rate | min | max |
| 1 | 25 | 25 | 25 | 1 | 1 |
| 2 | 25 | 50 | 25 | 1 | 2 |
| 3 | 50 | 100 | 50 | 1 | 4 |
| 4 | 75 | 150 | 50 | 2 | 5 |
| 5 | 150 | 300 | 150 | 3 | 10 |
| 6 | 300 | 600 | 300 | 5 | 20 |

### Receiving and Aggregating Reported Presentations

Referring now back to FIG. 6, if it is determined back at block 602 by a transaction engine that a “request” for advertisements has not been received, the transaction engine further determines if it has received a report of an advertisement presentation, block 610. If the determination is affirmative, the transaction engine logs the reported presentation, block 612. Otherwise, the process continues back at block 602. In one embodiment, the reported presentation is logged into a temporary log file (which as described earlier, is periodically transferred to logging service 116 for aggregation).

However, if it is determined back at block 612 that a report of an advertisement presentation has not been received, the transaction engine further determines if it is time to transfer the logged data to logging service 116, block 614. If the determination is affirmative, the transaction engine transfers the logged data to logging service 116, block 616. Otherwise, the process continues back at block 602.

However, if it is determined back at block 614 that it is not time to transfer the logged data to logging service 116, the transaction engine further determines if it is time to update the selection weights it employs in making the advertisement selections, block 616. If the determination is affirmative, the transaction engine contacts manager 120 to obtain the most current set of selection weights to be employed for the probabilistic advertisement selection, block 618. Either way, the process continues back at block 602.

In alternate embodiments, the reporting may be made to other separate and/or dedicated reporting receiving components/services instead (as opposed to the transaction engines.)

### Logging Service

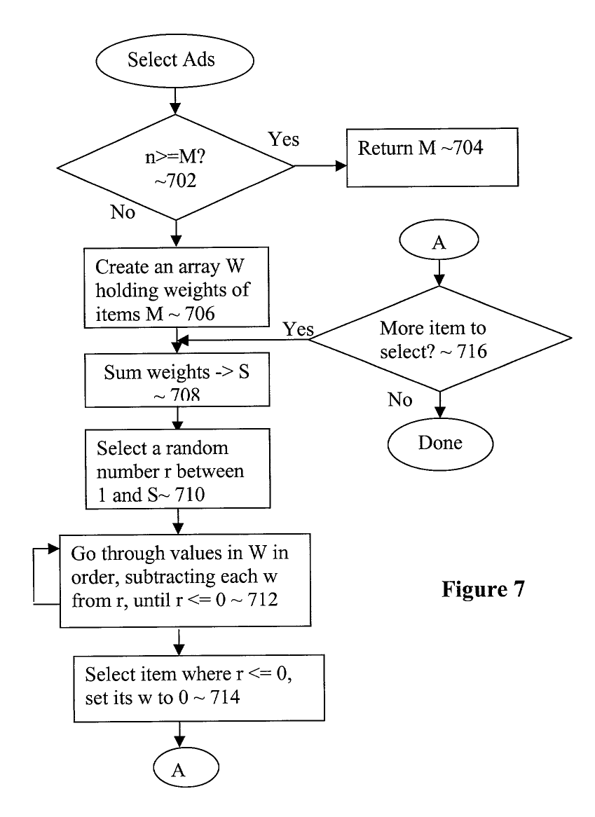

As described earlier, logging service 116 is employed to receive from transaction engines 114 periodically the logged presentations of the various advertisements, as reported to transaction engines 114 by client devices 102. FIG. 8 illustrates a process for aggregating the reported presentations, in accordance with one embodiment. As illustrated, when it is time to perform the aggregation, logging service 116 selects a log file transferred by one of the transaction engines, block 802. Next, logging service 116 processes the presentations logged, updating database 118 with the actual presentations made for the reported advertisements. Thereafter, logging service 116 determines if additional log files are to be processed, block 806. If there are, the process returns to block 802, otherwise the process terminates.

### Client Operation—Ad Management Extension

As described earlier, client devices 102 are equipped with generic agents, such as browsers 104, enhanced with advertisement management extensions (AME) 106. AMEs 106 incorporated with the teachings of the present invention interact with ad server 112 to facilitate advertisements to be presented to users of client devices 102 in accordance with desired flight profiles of the advertisers.

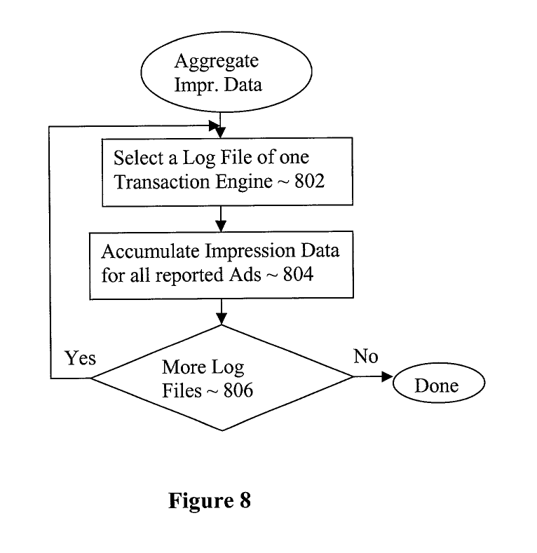

FIGS. 9-11 illustrate the operation flow of the relevant aspects of AME 106 of FIG. 1, including the organization of local cache 108, and associated working data structures, in accordance with one embodiment. More specifically, FIG. 9 illustrates local cache 108 in more detail. As illustrated, local cache 108 includes directory 904 for storing control information associated with the “provided” advertisements. For the embodiment, only control information including the location information of the advertisements are provided, the advertisements themselves are not “provided” initially. The control information for each advertisement includes in particular, an identifier (Ad id) for identifying the advertisement, a valid bit indicating whether the advertisement is eligible for selection for presentation, a location identifier (e.g. an URL) pointing to the remote storage location where the advertisement may be retrieved, a minimum counter (min) denoting the minimum number of impressions the advertisement is to be presented to the user of the client device, a maximum counter (max) denoting the maximum number of impressions the advertisement is to be presented to the user of the client device, and an actual counter (count) denoting the actual number of impressions the advertisement has been presented to the user of the client device. Further, as illustrated, for efficiency of operation, AME 106 also maintains a persistent valid counter 902 denoting the total number of valid (i.e. eligible) advertisements held in local cache 108. Additionally, upon retrieval, local cache 108 is also used to locally cache the retrieved advertisement. [Recall from earlier description, in alternate embodiments, the retrieved advertisements may be cached in the browser's temporary file storage or other stores.]

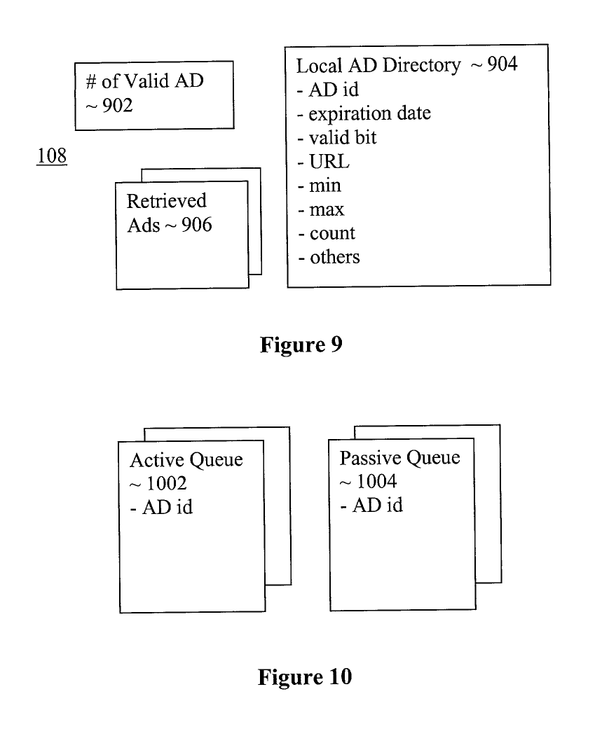

For efficiency of operation, AME 106 employs a number of working queues to facilitate presentations of the provided advertisements to its user. FIG. 10 illustrates the working queues in further detail, in accordance with one embodiment. As illustrated, at least two queues, referred to as active and passive queues 1002 and 1004 are employed for each media type of advertisements. Media types are banner, audio, video and so forth. Each active queue 1002 is employed to store the identifiers of advertisements (of the particular media type) provided in response to search activities of client device 102, whereas each passive queue 1004 is employed to store the identifiers of both previously received advertisements and pre-provided advertisements (of the particular media type) to be presented to the user of client device 102.

For the illustrated embodiment, AME 106 systematically processes the queues (of the different media types) and present the queued advertisements. In one embodiment, for each media type, AME 106 first processes the queued entries of active queue 1002 one time through then moves all ads in the active queue to the passive queue. Once the active queue is processed, the extension then processes ads in the passive queue in a round robin fashion, 1002. In alternate embodiments, other “play” algorithms, e.g. ones that favor queued advertisements with below minimum counts over those with above minimum counts, may be employed instead.

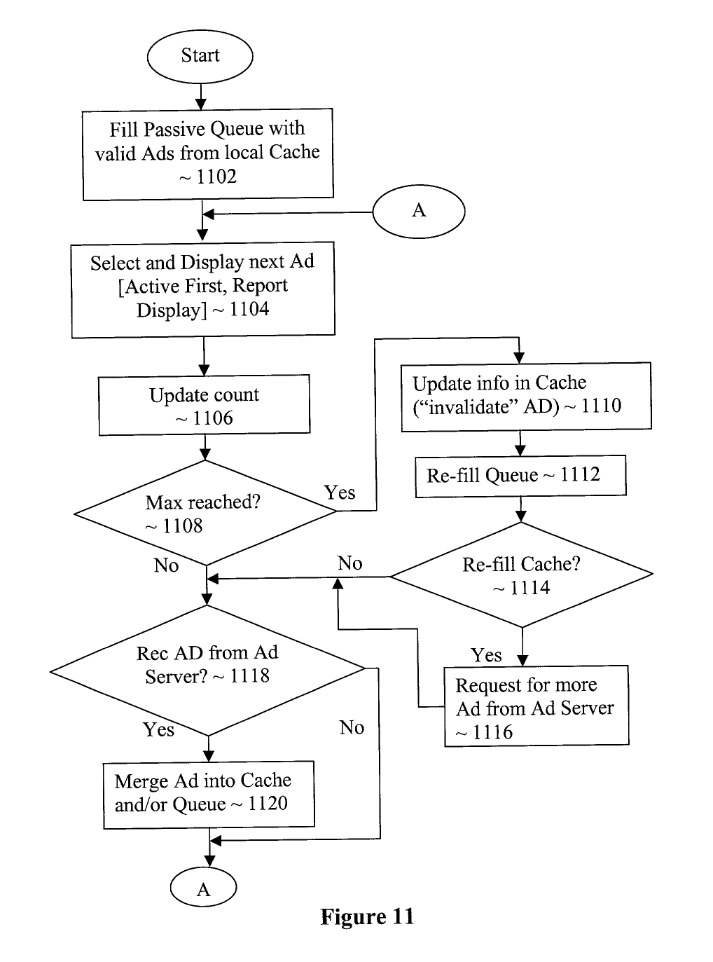

FIG. 11 illustrates the operational flow of the relevant aspects of advertisement management extension 106, in accordance with one embodiment. As illustrated, upon invocation, advertisement management extension (AME) 106 first fills passive queues 1104 with selected ones of advertisements “stored” in local cache 108, block 1102. In one embodiment, AME 106 selects the advertisements randomly. In alternate embodiments, AME 106 may select the advertisements using a weighted approach similar to the transaction engines 114. Thereafter, AME 106 systematically presents the queued advertisements, block 1104. [Since active queues 1104 queues the advertisements provided in response to search activities, these queues are “empty” initially.] For the illustrated embodiment, AME 106 also reports each presentation in real time to a transaction engine of ad server 112. Alternative embodiments can batch report collections of presentations to a transaction engine in order to reduce transaction overhead. Further, AME 106 updates the actual presentation count of the advertisement, block 1106.

Upon updating, AME 106 determines if the maximum number of presentations has been reached, block 1108. If so, AME 106 updates the control information in local cache 108, in particular, “invalidating” the advertisement whose maximum presentation has been reached, block 1110. In replacement of the advertisement becoming ineligible, AME 106 selects another advertisement from local cache 108 to replace the advertisement that became ineligible, block 1112.

For the illustrated embodiment, AME 106 further determines if the number of valid advertisements remain stored in local cache 108 has dropped below a predetermined threshold. If so, AME 106 requests ad server 112 (through a dynamically assigned transaction server 114) for additional advertisements to replenish the depleted advertisements, 1116.

Thereafter, whether having made the replenishment request, or whether it was earlier decided that the maximum number of impressions has not been reached at block 1108, AME 106 determines if new advertisements are being provided by ad server 112, block 1118. The new advertisements may be provided in response to an explicit request as early described in connection with block 1116, or as earlier described in response to a search being conducted by a user of the client device. If no advertisements are being provided, the process continues back at block 1104.

However, if advertisements are being provided, AME 106 accepts the advertisements and processes them for storage into local cache 108. The processing includes in particular, whether an advertisement has been previously provided, and if so whether the maximum count has already been reached. If an advertisement is a new advertisement not in the local cache, a new record is made, and the advertisement is stored. If it is an existing advertisement, a check of the min-max parameters is made to determine if the advertisement remain or may become eligible again. Further, a check is made to see if the advertisement is provided in association with a search being conducted. If so, the advertisement is immediately included (in the front of the appropriate active queue) as one of the queued advertisement, replacing an existing queued advertisement if necessary. In other words, the present invention is advantageously able to efficiently prevent the flight profiles from being substantially satisfied by a small group of users.

In one embodiment, advertisements having been presented a number of times close to the specified maximum parameter are selected to make room in the queues, if necessary. Similarly, a least recently used (LRU) like approach is used to make room in local cache 106 if necessary (e.g. when all stored advertisements are still valid; in other words, none has reached the maximum count). Obviously, all associated control data, such as the number of valid advertisements, and so forth, are timely updated accordingly. Thereafter, the process continues back at block 1304.

Accordingly, AME 106 is able to collaborate with ad server 112 to facilitate achievement of the desired flight profiles of the advertisements.

### Example Computer System

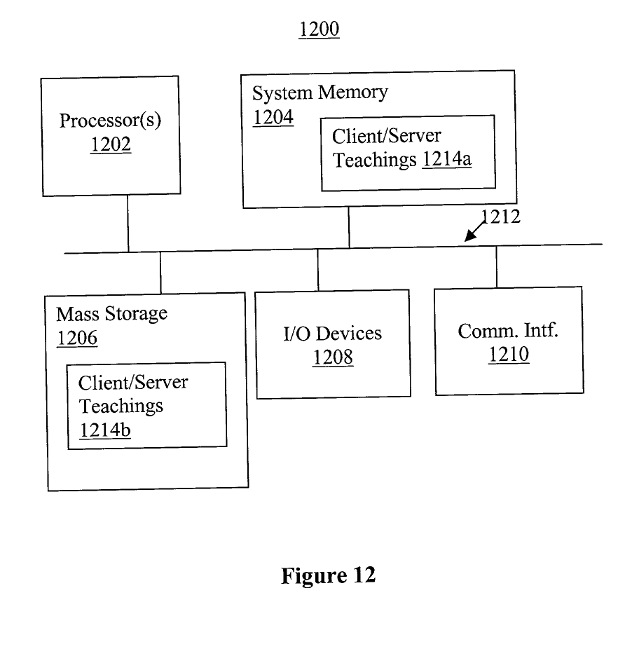

FIG. 12 illustrates an example computer system suitable for use as an implementing data processing server of ad server 112 or as a client device 102, in accordance with one embodiment. As shown, computer system 1200 includes one or more processors 1202 and system memory 1204. Additionally, computer system 1200 includes mass storage devices 1206 (such as diskette, hard drive, CDROM and so forth), input/output devices 1208 (such as keyboard, cursor control and so forth) and communication interfaces 1210 (such as network interface cards, modems and so forth). The elements are coupled to each other via system bus 1212, which represents one or more buses. In the case of multiple buses, they are bridged by one or more bus bridges (not shown). Each of these elements performs its conventional functions known in the art. In particular, system memory 1204 and mass storage 1206 are employed to store a working copy and a permanent copy of the programming instructions implementing one or more of the components of ad server 112 or advertising management extension 106 of the present invention. The permanent copy of the programming instructions of advertising management extension 106 may e.g. be downloaded into mass storage 1206 through communication interface 1210. The constitution of these elements 1202-1212 are known, and accordingly will not be further described.

### Conclusion and Epilogue

Thus, it can be seen from the above descriptions, a novel method and apparatus for a distributed approach to managing advertisement presentations per desired flight profiles has been described. The novel method/apparatus is advantageously scalable to support a very large number of client computers.

While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. A method for managing advertisement presentation comprising:
an advertisement server making an initial selection and provision of a plurality of advertisements for a number of client devices for presentation in accordance with corresponding desired flight profiles to be achieved for the advertisements, and including with said provision one or more presentation parameters to govern the rates in which the provided advertisements are to be presented;
the client devices selectively presenting said advertisements in accordance with said governing presentation parameters, and reporting their presentations; and
the advertisement server repeating said selection and provision of advertisements further taking into consideration said reports.

2. The method of claim 1, wherein each of said selections and provisions of advertisements comprises probabilistically selecting said advertisements.

3. The method of claim 2, wherein each of said probabilistic selections comprises determining a set of weights for use to perform the probabilistic selection.

4. The method of claim 1, wherein said one or more presentation parameters comprise a minimum and a maximum presentation parameter, and each of said selections and provisions of advertisements comprises determining and providing one each of said minimum and maximum presentation parameters for each selected advertisement.

5. A method for managing advertisement presentation comprising:
selecting and providing a plurality of client devices with different pluralities of advertisements for presentation on the client devices, in accordance with corresponding desired flight profiles to be achieved for the advertisements, and including with said provision one or more presentation parameters to govern the rates in which the provided advertisements are to be presented on the client devices;
receiving reports of presentation from said client devices; and
repeating said selection and provision of advertisements further taking into consideration said reports.

6. The method of claim 5, wherein each of said selections and provisions of advertisements comprises probabilistically selecting said advertisements.

7. The method of claim 6, wherein the method further comprises obtaining a set of weights for said advertisements for use to perform said probabilistic selections, and periodically obtaining update replacements for said weights.

8. The method of claim 7, wherein the method further comprises determining and periodically re-determining said weights to be employed for said probabilistic selections.

9. The method of claim 8, wherein each of said weight determinations is made in accordance with residual amounts of said desired flight profiles remain to be achieved for said advertisements.

10. The method of claim 9, wherein the method further comprises aggregating said reported presentations, and determining said residual amounts of the desired flight profiles of the advertisements remain to be achieved.

11. The method of claim 7, wherein each of said probabilistic selections further comprises successively generating a plurality of random numbers, and using said successively generated random numbers, in conjunction with said weights, to successively select said advertisements.

12. The method of claim 6, wherein each of said probabilistic selections further comprises generating a plurality of random numbers for use to perform the probabilistic selection.

13. The method of claim 5, wherein said one or more presentation parameters comprise a minimum and a maximum presentation parameter, and each of said selections and provisions of advertisements comprises determining and providing one each of said minimum and maximum presentation parameters for each selected advertisement.

14. The method of claim 13, wherein each of said determining and providing of one each of said minimum and maximum presentation parameters for each selected advertisement is performed in view of a presentation rate to be achieved.

15. The method of claim 5, wherein said selecting and providing of advertisements are further made in view of demographic profiles of said client devices.

16. The method of claim 5, wherein said selecting and providing of advertisements are further made in view of subject matters of searches being performed by said client devices.

17. The method of claim 5, wherein said selecting and providing of advertisements are performed in response to requests of said client devices for additional advertisements.

18. The method of claim 5, wherein said selecting and providing of advertisements are performed in response to searches being performed by said client devices.

19. In a client device, a method of operation comprising:
receiving a plurality of advertisements for presentation on the client device, including for each of said received advertisements, one or more presentation parameters governing the rates in which the provided advertisements are to be presented on the client device;
selectively presenting said received advertisements in accordance with said governing presentation parameters; and
reporting said selective presentations.

20. The method of claim 19, wherein said one or more presentation parameters comprise a minimum and a maximum presentation parameter, and said selective presentation comprises selecting said received advertisements for presentation in accordance with the minimum and maximum presentation parameters of said received advertisements.

21. The method of claim 20, wherein said method further comprises tracking the number of times each of said received advertisements has been selected for presentation.

22. The method of claim 20, wherein said method further comprises rendering an advertisement ineligible for selection for presentation when the number of times the advertisement has been selected for presentation reaches the advertisement's maximum presentation parameter.

23. The method of claim 19, wherein the method further comprises determining whether additional advertisements are needed, and requesting an advertisement server for additional advertisements.

24. The method of claim 19, wherein the method further comprises informing an advertisement server of demographic data of the client device.

25. The method of claim 19, wherein the method further comprises informing an advertisement server of subject matters of searches being performed by the client device.

26. An apparatus comprising:
storage medium having stored therein a plurality of programming instructions designed to
select and provide a plurality of client devices with different pluralities of advertisements for presentation on the client devices, in accordance with corresponding desired flight profiles to be achieved for the advertisements, and to include with said provision one or more presentation parameters to govern the rates in which the provided advertisements are to be presented on the client devices, receive reports of presentation from said client devices, and repeat said selection and provision of advertisements further taking into consideration said reports; and
one or more processors coupled to the storage medium to execute the programming instructions.

27. The apparatus of claim 26, wherein said programming instructions are designed to make each of said selections and provisions of advertisements by probabilistically selecting said advertisements.

28. The apparatus of claim 27, wherein said programming instructions are further designed to obtain a set of weights for said advertisements for use to perform said probabilistic selections, and to periodically obtain update replacements for said weights.

29. The apparatus of claim 28, wherein said programming instructions are further designed to determine and periodically re-determine said weights to be employed for said probabilistic selections.

30. The apparatus of claim 29, wherein said programming instructions are designed to make each of said weight determinations in accordance with residual amounts of said desired flight profiles remain to be achieved for said advertisements.

31. The apparatus of claim 30, wherein said programming instructions are further designed to aggregate said reported presentations, and to determine said residual amounts of the desired flight profiles of the advertisements remain to be achieved.

32. The apparatus of claim 28, wherein said programming instructions are designed to successively generate a plurality of random numbers, and use said successively generated random numbers, in conjunction with said weights, to successively select said advertisements.

33. The apparatus of claim 27, wherein said programming instructions are further designed to generate a plurality of random numbers for use to perform the probabilistic selection.

34. The apparatus of claim 26, wherein said one or more presentation parameters comprise a minimum and a maximum presentation parameter, and said programming instructions are designed to determine and provide one each of said minimum and maximum presentation parameters for each selected advertisement.

35. The apparatus of claim 34, wherein said programming instructions are designed to perform each of said determining and providing of one each of said minimum and maximum presentation parameters for each selected advertisement in view of a presentation rate to be achieved.

36. The apparatus of claim 26, wherein said programming instructions are further designed to perform said selecting and providing of advertisements in view of demographic profiles of said client devices.

37. The apparatus of claim 26, wherein said programming instructions are further designed to perform said selecting and providing of advertisements in view of subject matters of searches being performed by said client devices.

38. The apparatus of claim 26, wherein said programming instructions are further designed to perform said selecting and providing of advertisements in response to requests of said client devices for additional advertisements.

39. The apparatus of claim 26, wherein said programming instructions are further designed to perform said selecting and providing of advertisements in response to searches being performed by said client devices.

40. An apparatus comprising:
storage medium having stored therein a plurality of programming instructions designed to
receive a plurality of advertisements for presentation on the client device, including for each of said received advertisements, one or more presentation parameters governing the rates in which the provided advertisements are to be presented on the client device, selectively present said received advertisements in accordance with said governing presentation parameters, and report said selective presentations; and
a processor coupled to the storage medium to execute the programming instructions.

41. The apparatus of claim 40, wherein said one or more presentation parameters comprise a minimum and a maximum presentation parameter, and said programming instructions are designed to select said received advertisements for presentation in accordance with the minimum and maximum presentation parameters of said received advertisements.

42. The apparatus of claim 41, wherein said programming instructions are further designed to track the number of times each of said received advertisements has been selected for presentation.

43. The apparatus of claim 41, wherein said programming instructions are further designed to render an advertisement ineligible for selection for presentation when the number of times the advertisement has been selected for presentation reaches the advertisement's maximum presentation parameter.

44. The apparatus of claim 40, wherein said programming instructions are further designed to determine whether additional advertisements are needed, and request an advertisement server for additional advertisements.

45. The apparatus of claim 40, wherein said programming instructions are further designed to inform an advertisement server of demographic data of the client device.

46. The apparatus of claim 40, wherein said programming instructions are further designed to inform an advertisement server of subject matters of searches being performed by the client device.
